(19) United States
(12) Patent Application Publication
(10) Pub. No.: US 2016/0001972 A1
(43) Pub. Date: Jan. 7, 2016

(54) INSPECTION PORT FOR INSULATED TANK CAR

(71) Applicant: GATX Corporation, Chicago, IL (US)

(72) Inventors: Anthony G. Sisto, Orland Park, IL (US); Gabriel L. Buzas, Chicago, IL (US); Peter R. Manyek, Highland, IN (US)

(21) Appl. No.: 14/793,185

(22) Filed: Jul. 7, 2015

Related U.S. Application Data
(60) Provisional application No. 62/021,337, filed on Jul. 7, 2014.

(51) Int. Cl. B65D 90/06; G01N 21/95; G01N 21/88; B65D 88/12; B65D 90/10

(52) U.S. Cl. CPC B65D 90/06; B65D 88/128; B65D 90/10; G01N 21/8803; G01N 21/95

(57) ABSTRACT

An inspection port is provided for allowing inspection of an insulated tanker. The insulated tanker may include a tank shell configured for containing a fluid, and a jacket disposed at least partially around, and spaced from, the tank shell to define a volume between the tank shell and the jacket. An insulation layer may be disposed between the tank shell and the jacket. An inspection port may include an opening formed in the jacket. The inspection port may provide access to at least a portion of an exterior of the tank shell. A cover plate may be disposed over the inspection port, and may be mechanically fastened relative to the jacket.

### CROSS-REFERENCE TO RELATED APPLICATIONS

This application claims the benefit of U.S. provisional patent application Ser. No. 62/021,337, entitled “Tank Car Removable Jacket Inspection Port,” filed on Jul. 7, 2014, the entire disclosure of which is incorporated herein by reference.

### TECHNICAL FIELD

The present disclosure generally relates to insulated tank cars, and more particularly relates to configurations for allowing inspection of an inner tank shell of an insulated tank car.

### BACKGROUND

Material transport is a crucial aspect of modern economies. A wide variety of raw materials, intermediate products, and finished goods are constantly being shipped across the globe, and through countries. For example, raw material must be transported from a point of origin, such as where the raw materials are harvested, mined, or otherwise produced, to locations where the raw materials can be process to produce intermediate products or finished goods. Similarly, intermediate products may further be transported to still other locations where they can be further transformed to produce finished goods. Such finished goods must often be transported further to bring the goods to market. Such constant transportation is often required because each link in the production chain may require a different combination of resources, including natural resources, available labor, suitable economic environment, and so forth.

Various different modes of transport are available to suit different varieties of products and different geographic avenues of shipment. In the case of liquid and gaseous products, bulk transport often relies on tank containers of some variety that may be suitable for holding liquids or gasses, and that may also facilitate easy loading and off-loading of the liquids or gasses. Such tank containers may be configured, for example, as a railcar for transport via railroad, as a towable trailer for transport by highway, e.g., towed by a tractor as part of a tractor-trailer assembly, or otherwise configured for suitable transport. Such tank containers may include various different features, depending upon the nature of the liquid or gaseous product, as well as any particular handling considerations that may be associated with the material transported within the tank containers. In some situations, it may be desirable to at least partially control the temperature within the tank container. For example, it may be desirable to maintain the liquid or gaseous product within the tank container above or below the ambient temperature outside of the tank container, or to reduce the impact of ambient temperature, or ambient temperature changes, on the liquid or gaseous product within the tank container. In such situation, an insulated tank container may be utilized, which may provide a layer of thermal insulation at least partially surrounding the tank.

### SUMMARY

According to an implementation, an insulated tanker may include a tank shell configured for containing a fluid. The insulated tanker may also include a jacket disposed at least partially around the tank shell and may be spaced therefrom, defining a volume between the tank shell and the jacket. An insulation layer may be disposed between the tank shell and the jacket. An inspection port may include an opening formed in the jacket. The inspection port may provide access to at least a portion of an exterior of the tank shell. A cover plate may be disposed over the inspection port, and may be mechanically fastened relative to the jacket.

One or more of the following features may be included. The jacket and the cover plate may include sheet metal. The insulated tanker may include an inspection port frame. The inspection port frame may include a reinforcing feature formed around at least a portion of a periphery of the inspection port. The inspection port frame may include a sheet metal structure defining an opening at least generally corresponding to the inspection port. The inspection port frame may be coupled with the jacket. The inspection port frame may be welded to the jacket.

The cover plate may be mechanically fastened to the jacket and to the inspection port frame. The cover plate may be bolted to the jacket. The cover plate may be bolted to the jacket via a captured nut associated with one or more of the jacket and the inspection port frame.

The inspection port may be located relative to the tank shell to permit visual inspection of one or more weld sites of the tank shell. The insulation layer may include a fiberglass insulation. The insulated tanker may include an insulated rail tank car. The insulated tanker may include an insulated tractor trailer tanker trailer.

According to another implementation, a method for inspecting weld sites of a tank shell may include forming an inspection port in a jacket of an insulated tanker. The inspection port may include an opening in the jacket proximate a weld site to be inspected. The method may also include visually inspecting the weld site of the tank shell via the inspection port. The method may further include mechanically fastening a cover plate over the inspection port to cover the inspection port.

One or more of the following features may be included. An inspection port frame may be formed around at least a portion of the opening in the jacket. The inspection port frame may include a sheet metal body having an opening at least generally corresponding to the opening formed in the jacket. Forming the inspection port frame may include coupling the inspection port frame to the jacket. Coupling the inspection port frame to the jacket may include welding at least a portion of the sheet metal body to the jacket.

Mechanically coupling the cover plate over the inspection port may include bolting the cover plate to one or more of the jacket and the inspection port frame. Bolting the cover plate over the inspection port may include bolting the cover plate using a captured nut. The method may further include re-inspecting the weld site. Re-inspecting the weld site may include removing the cover plate. The weld site may be inspected. The cover plate may be re-affixed over the inspection port using a mechanical fastener.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts an example of an insulated rail tank car, according to an example embodiment consistent with the present disclosure;

FIG. 2 is an exploded view of a portion of the insulated rail tank car of FIG. 1, including an inspection port frame and cover plate, according to an example embodiment consistent with the present disclosure; and

FIG. 3 is an example embodiment of a clip nut, according to an example embodiment consistent with the present disclosure.

Like reference symbols in the various drawings indicate like elements.

### DETAILED DESCRIPTION OF EXAMPLE EMBODIMENTS

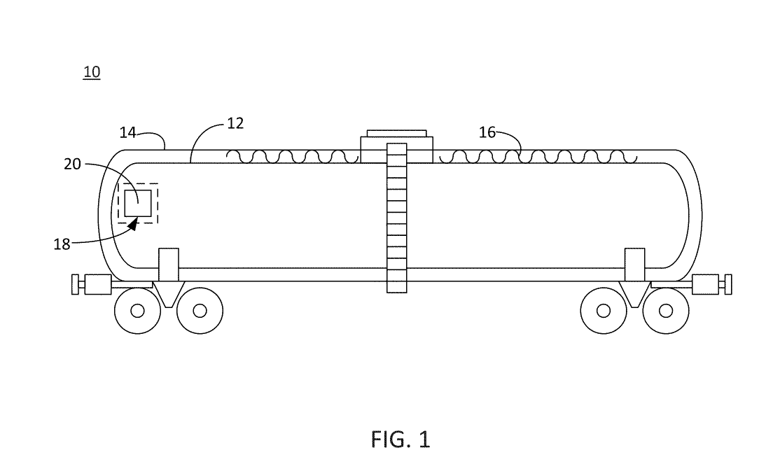

Referring to FIG. 1, an illustrative insulated tanker 10 is generally shown. Insulated tanker 10 may be generally configured for containing and/or transporting fluids, such as liquids and or gaseous materials. While the illustrative insulated tanker shown in FIG. 1 is an insulated rail tank car, it will be appreciated that the insulated tanker may take other forms and/or be implemented for other modes of transport. For example, the insulated tanker may include an insulated tanker trailer, e.g., as may be towed by a tractor as part of a tractor-trailer arrangement. Other configurations may also be implemented. Insulated tanker 10 may include tank shell 12, that may be configured for containing the fluid for storage and/or transport. In general, tank shell 12 may include a structural body, e.g., a welded steel or aluminum vessel, a composite vessel (e.g., fiberglass, glass reinforced plastic, etc.), or the like, which may depend, at least in part, upon the structural requirements of tank shell 12, the fluid to be contained within insulated tanker, as well as various other considerations. As shown, tank shell 12 may have a generally cylindrical shape, and may include domed end portions. However, it will be appreciated that other configurations may be utilized.

Insulated tanker 10 may also include jacket 14. Jacket 14 may be disposed at least partially around tank shell 12. For example, as shown in the illustrated example of FIG. 1, jacket 14 may be disposed completely around tank shell 12. Further, jacket 14 may be at least partially spaced from tank shell 12, thereby defining a volume between jacket 14 and tank shell 12. Jacket 14 may generally include a sheet metal body, for example, including sheet steel or sheet aluminum. However, it will be appreciated that other materials, such as fiberglass (or other composite) materials, fiber reinforced plastic, and the like, may be utilized. In some embodiments, jacket 14 may be shaped generally similarly to tank shell 12. As such, the volume between jacket 14 and tank shell 12 may be generally uniform. However, it will be appreciated that other configurations may be implemented, wherein the spacing between jacket 14 and tank shell 12 may be different at different locations about insulated tanker 10. Further, while not shown, it will be appreciated that one or more structural or support members may be at least partially disposed between tank shell 12 and jacket 14, to transfer the weight of tank shell 12, including any fluid contained therein, to any structural features (e.g. a chassis of tanker 10, axle/wheel assemblies, coupling assemblies, or the like).

Insulation layer 16 may be disposed between tank shell 12 and jacket 14. While insulating layer 16 is only depicted in a portion of the volume between tank shell 12 and jacket 14, it will be appreciated that insulation layer 16 may extend substantially between the entirety of tank shell 12 and jacket 14 (e.g., to provide substantially complete insulation between tank shell 12 and jacket 14). It will be appreciated that various structure may extend between tank shell 12 and jacket 14, e.g., which may preclude insulation, and thereby make insulation layer 16 locally discontinuous around such structures. Examples of structures extending between tank shell 12 and jacket 14 may include, but are not limited to, manways, filling conduits, support structure, or the like. Additionally, while insulation layer 16 may be generally uniform around tank shell 12, in some embodiments one or more portions of insulation layer 16 may be relatively thicker than one or more other portions of insulation layer 16. For example, in an example embodiment, insulation layer 16 may be relatively thicker around the top half of tank shell 12 and may be relatively thinner around the bottom half of tank shell 12. In an embodiment, insulation layer 16 may include a fiberglass insulation. However, various other types of insulation may also be utilized, such as foam insulations (e.g., expanded polystyrene, urethane foam, etc.). Further, in some embodiments, more than one insulation type may be utilized, e.g., either throughout the entirety of insulation later 16, and/or in different regions of insulation layer 16.

Insulated tanker 10 may also include an inspection port (e.g., inspection port 18, generally indicated in FIG. 1). In general, inspection port 18 may include an opening formed in jacket 14. For example, inspection port 18 may provide access to at least a portion of an exterior of tank shell 12. As generally described above, tank shell 12 may provide a structural vessel that may contain the fluid to be transported via insulated tanker 10. As tank shell 12 may be contained within jacket 14 and insulation layer 16, inspecting tank shell 12 may be difficult if not impossible. For example, tank shell 12 may include one or more components that may be joined together, such as welded steel or aluminum plates. Over time the welds between the various portions of tank shell 12 may deteriorate and/or may suffer from corrosion, stress fracture, or the like. As such, it may be desirable to periodically inspect tank shell 12. Inspection port 18 may include an opening formed in jacket 14 that may provide access to at least a portion of an exterior of tank shell 12, for example, at one or more weld sites of tank shell 12 (such as a portion of a seam or weld between portions of tank shell 12). Inspecting the area or interest (such as a weld site) may include visually inspecting tank shell 12 (e.g., directly and/or via video imaging), and/or may include other, non-visual inspection techniques. It will be appreciated that accessing tank shell 12 for inspection may include permanently and/or temporarily removing at least a portion of insulation layer 16 (e.g. a portion of insulation layer 16 overlying the weld site, or other portion of tank shell 12, that is being inspected). In an embodiment, inspection port 18 may be formed in jacket 14 during manufacture of insulated tanker 10. In other embodiments, inspection port 18 may be formed in jacket 14 of an existing insulated tanker. In such an embodiment, inspection port 18 may be formed by removing a portion of jacket 14, as by cutting with a cutting torch, plasma cutter, saw, abrasive cutter, or other suitable technique for forming inspection port 18 opening in jacket 14.

While inspection port 18 is depicted as a generally rectangular opening, it will be appreciated that inspection port 18 may include a variety of different shapes and configurations, as may be suitable for accomplishing various desired inspection operations. Additionally, it will be appreciated that the position, size, and orientation of inspection port 18 shown in FIG. 1 is intended for illustrative purposes only, as the size, location, and orientation of inspection port 18 may vary according to need (e.g., based upon a portion of tank shell 12 to be inspected). Further, while only a single inspection port is shown in FIG. 1, it will be appreciated that insulated tanker 10 may include any number of inspection ports as may be appropriate to accomplished a desired degree of inspection of tank shell 12.

Insulated tanker 10 may further include cover plate 20. Cover plate 20 may be configured to be disposed over inspection port 18, e.g., to enclose jacket 14, and/or render jacket 14 generally continuous around tank shell 12 when tank shell 12 is not being inspected. In this regard, cover plate 20 may include any suitable material, such as sheet metal (e.g., which may be the same metal and/or thickness as jacket 14, and/or may differ from jacket 14), a composite material, a fiber reinforced plastic, or other suitable material. In an embodiment, cover plate 20 may be mechanically fastened relative to jacket 14, e.g., to provide relatively facile removal of cover plate 20 to permit access to tank shell 12 via inspection port 18 for carrying out a desired inspection. Further, upon completion of a desired inspection operation, cover plate 20 may be re-affixed to jacket 14 using mechanical fasteners, e.g., to thereby re-enclose jacket 14. Examples of suitable mechanical fasteners may include bolts, rivets (e.g., which may be drilled out to remove cover plate 20, and new rivets subsequently installed to re-affix cover plate 20 relative to jacket 14), or any other suitable mechanical fastener. In some embodiments, mechanically fastening cover plate 20 relative to jacket 14 may provide a suitable degree of enclosure of jacket 14 relative to insulation layer 16 and tank shell 12. In other embodiments, a higher degree of weather-tightness may be desired. Accordingly, various gaskets, seals, sealants, or the like may be utilized to provide a desired degree of weather-tightness.

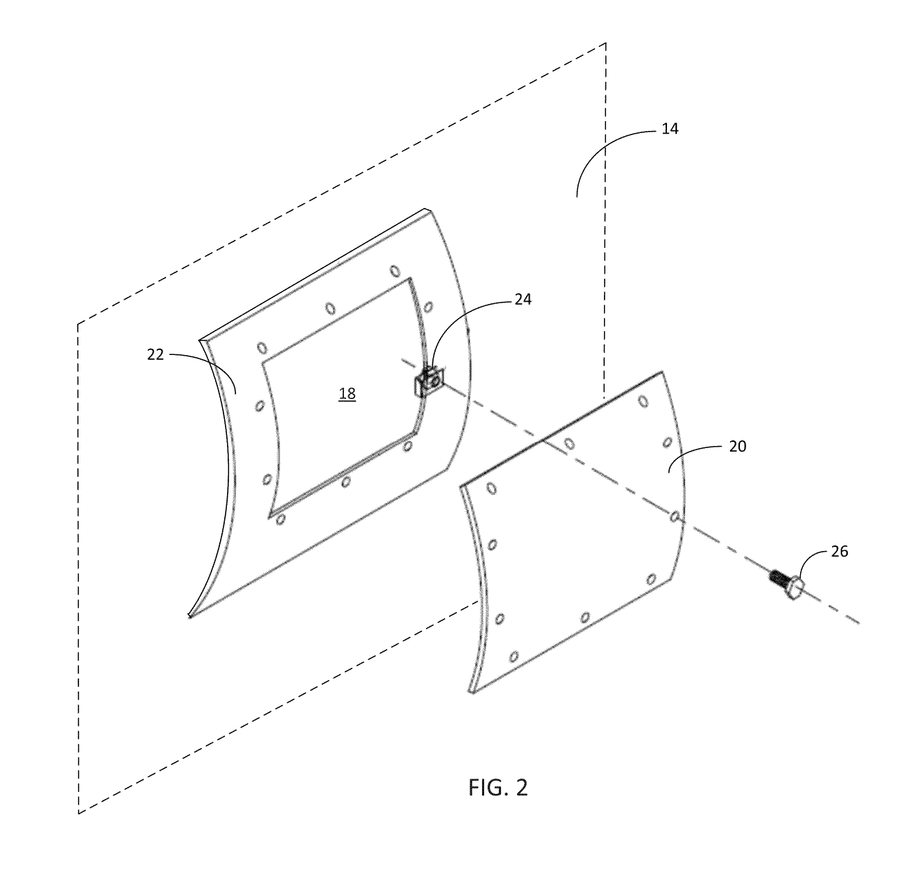

Referring also to FIG. 2, in an embodiment, insulated tanker 10 may include inspection port frame 22. In general, inspection port frame 22 may include a reinforcing feature formed around at least a portion of a periphery of the inspection port 18. For example, as shown, inspection port frame 22 may include a plate, or other reinforcing structure, that may be disposed around at least a portion of inspection port 18, and may include an opening that may at least generally correspond (e.g., in size, shape, and/or position) to inspection port 18. In an embodiment, inspection port frame 22 may include a sheet metal structure having an opening corresponding to the opening of inspection port 18. Further, inspection port frame 18 may be coupled with jacket 14. In the foregoing manner, inspection port frame 22 may provide a localized reinforcement of jacket 14 in the region of inspection port 18. In an embodiment in which inspection port frame 22 includes a sheet metal structure that includes a similar metal as jacket 14, inspection port frame 22 may be welded to jacket 14 to thereby couple inspection port frame 22 with jacket 14. In such an embodiment, inspection port frame may be continuously and/or intermittently welded to jacket 14 about one, or both, of the exterior periphery and the interior periphery of inspection port frame 22. In other embodiments, inspection port frame 22 may be coupled with jacket 14 using various other suitable means, such as adhesive bonding, riveting, bolting, or the like.

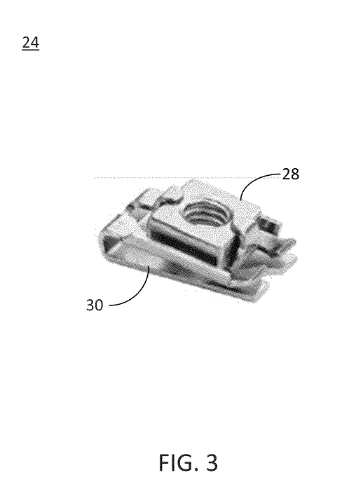

As shown in FIG. 2, in an embodiment in which jacket 14 may be reinforced in the region of inspection port 18 via inspection port frame 22, cover plate 20 may be mechanically fastened to jacket 14 and to inspection port frame 22. For example, cover plate 20 may be bolted to inspection port frame 22 and jacket 14. In an embodiment, cover plate 20 may be bolted to jacket 14 via a captured nut associated with one or more of jacket 14 and inspection port frame 22. For example, as shown in the illustrated embodiment, clip nut 24 may be disposed over jacket 14 and inspection port frame 22 around the periphery of inspection port 18. Further, cover plate 20 may be secured relative to jacket 14 and/or inspection port frame 22 using bolts (e.g., bolt 26), that may threadably engage the clip nuts (e.g., clip nut 24). While only a single clip nut is shown in FIG. 2, it will be appreciated that a respective clip nut may be utilized at each desired bolt location from attaching cover plate 20 relative to jacket 14 and inspection port frame. Referring to FIG. 3, an example of clip nut 24 is depicted. As generally shown, clip nut 24 may include nut feature 28 that may be coupled to clip 30, e.g., to retain nut feature 28 relative to clip 30 and/or to prevent nut feature 28 from rotating independently of clip 30. Further, clip 30 may be sized to engage jacket 14 and/or inspection port frame 22, e.g., to retain clip nut 24 in a desired position while bolting cover plate 20 to jacket 14. While clip nut 24 has been depicted as an example of a captured nut, it will be appreciated that other captured nut configurations may be implemented. For example, a nut may be welded directly to jacket 14 and/or inspection port frame 22 at desired bolting locations. Further, in some embodiments, the holes formed in jacket 14 and/or inspection port frame 22 may be threaded for engaging bolts to retain cover plate 20 relative to jacket 14. While the illustrated embodiment depicts a ten bolt fastening arrangement, it will be appreciated that any suitable fastening arrangement may be implemented.

As generally described above, the inspection port may be used to allow inspection of at least a portion of the tank shell, e.g., which may normally be obscured by the jacket and/or the insulation layer. The inspection port may allow access to at least a portion of the tank shell, for example, to one or more weld sites on the exterior of the tank shell. As such, the inspection port may allow the weld sites, or other features, of the tank shell to be inspected, either visually, or via another suitable inspection technique. In an embodiment, an inspection port may be formed by cutting an opening in the jacket of an insulated tanker to provide access to an exterior of the tank shell for inspection. Following inspection, a cover plate may be secured over the inspection port. In this manner, the cover plate may re-enclose the jacket around the tank shell and insulation layer. In an embodiment in which at least a portion of the insulation layer around the feature of the tank shell being inspected was removed, suitable insulation may be replaced prior to enclosing the jacket using the cover plate.

In an embodiment, the jacket may be reinforced in the region of the inspection port, for example, to prevent distortion of the jacket, to prevent deterioration of the jacket, and/or to reestablish the strength and/or integrity of the jacket, which may be compromised by forming the inspection port in the jacket. The jacket may be reinforced by providing an inspection port frame, that may provide a reinforcing structure around the inspection port, and may include an opening that may generally correspond to the inspection port. The inspection port frame may be attached to the jacket in any suitable manner, such as welding, riveting, adhesive bonding, bolting, etc. In an embodiment in which an inspection port frame is utilized, the cover plate may be bolted to the inspection port frame and the jacket. In an embodiment in which the jacket and/or the inspection port frame may not provide sufficient thickness or strength to allow direct threaded engagement with bolt used for securing the cover plate, captured nuts, such as clip nuts, may be utilized to provide a desired degree of threaded securement for the cover plate.

It will be appreciated that, at some point in time, subsequent inspection of the tank shell may be desired. In such a situation, the tank shell (e.g., one or more weld sites or other features of the tank shell) may be re-inspected using the inspection port. For example, the cover plate may be removed from the inspection port, as by unbolting. A desired inspection of the exterior of the tank shell may be accomplished via the inspection port. Following the re-inspection of the tank shell, the cover plate may be re-affixed to the insulated tanker, e.g., as by bolting the cover plate to the jacket and the inspection port frame (if one is attacked to the jacket).

While the example embodiments herein have generally related to reinforcing structures and methods that may be implemented in connection with a transport tanker, such use is not intended to be a limitation on the present disclosure. Load spreading structures as described herein may suitably be used in connection with any weld terminations that may be subject to cyclic loading, such as structures on earth moving equipment, heavy machinery, ships and the like. For example, load spreading structures as described herein may be utilized to reinforce any weld termination, for example, by spreading and distributing concentrated loads and/or stresses that may be realized at an un-reinforced weld termination.

Having thus described the disclosure of the present application in detail and by reference to implementations thereof, it will be apparent that modifications and variations are possible without departing from the scope of the disclosure defined in the appended claims.

What is claimed is:

1. An insulated tanker comprising:
a tank shell configured for containing a fluid;
a jacket disposed at least partially around the tank shell and spaced therefrom, defining a volume between the tank shell and the jacket;
an insulation layer disposed between the tank shell and the jacket;
an inspection port including an opening formed in the jacket, the inspection port providing access to at least a portion of an exterior of the tank shell; and
a cover plate disposed over the inspection port, and mechanically fastened relative to the jacket.

2. The insulated tanker according to claim 1, wherein the jacket and the cover plate comprise sheet metal.

3. The insulated tanker according to claim 1, further comprising an inspection port frame including a reinforcing feature formed around at least a portion of a periphery of the inspection port.

4. The insulated tanker according to claim 3, wherein the inspection port frame includes a sheet metal structure defining an opening at least generally corresponding to the inspection port.

5. The insulated tanker according to claim 4, wherein the inspection port frame is coupled with the jacket.

6. The insulated tanker according to claim 5, wherein the inspection port frame is welded to the jacket.

7. The insulated tanker according to claim 3, wherein the cover plate is mechanically fastened to the jacket and to the inspection port frame.

8. The insulated tanker according to claim 7, wherein the cover plate is bolted to the jacket.

9. The insulated tanker according to claim 8, wherein the cover plate is bolted to the jacket via a captured nut associated with one or more of the jacket and the inspection port frame.

10. The insulated tanker according to claim 1, wherein the inspection port is located relative to the tank shell to permit visual inspection of one or more weld sites of the tank shell.

11. The insulated tanker according to claim 1, wherein the insulation layer includes a fiberglass insulation.

12. The insulated tanker according to claim 1, wherein the insulated tanker includes an insulated rail tank car.

13. The insulated tanker according to claim 1, wherein the insulated tanker includes an insulated tractor trailer tanker trailer.

14. A method for inspecting weld sites of a tank shell comprising:
forming an inspection port in a jacket of an insulated tanker, the inspection port including an opening in the jacket proximate a weld site to be inspected;
visually inspecting the weld site of the tank shell via the inspection port;
mechanically fastening a cover plate over the inspection port to cover the inspection port.

15. The method of claim 14, further including forming an inspection port frame around at least a portion of the opening in the jacket.

16. The method of claim 15, wherein the inspection port frame includes a sheet metal body having an opening at least generally corresponding to the opening formed in the jacket.

17. The method of claim 16, wherein forming the inspection port frame includes coupling the inspection port frame to the jacket.

18. The method of claim 17, wherein coupling the inspection port frame to the jacket includes welding at least a portion of the sheet metal body to the jacket.

19. The method of claim 15, wherein mechanically coupling the cover plate over the inspection port includes bolting the cover plate to one or more of the jacket and the inspection port frame.

20. The method of claim 19, wherein bolting the cover plate over the inspection port includes bolting the cover plate using a captured nut.

21. The method of claim 14, further comprising re-inspecting the weld site comprising:
removing the cover plate;
inspecting the weld site; and
re-affixing the cover plate over the inspection port using a mechanical fastener.
